(19) United States
(12) Patent Application Publication
(10) Pub. No.: US 2025/0373492 A1
(43) Pub. Date: Dec. 4, 2025

(54) NETWORK TRANSMISSION OPTIMIZATION METHOD AND APPARATUS, STORAGE MEDIUM, ELECTRONIC DEVICE, AND PROGRAM PRODUCT

(71) Applicant: Tencent Technology (Shenzhen) Company Limited, Shenzhen (CN)

(72) Inventors: Hange Zhou, Shenzhen (CN); Yong Yang, Shenzhen (CN)

(73) Assignee: Tencent Technology (Shenzhen) Company Limited, Shenzhen (CN)

(21) Appl. No.: 19/246,923

(22) Filed: Jun. 24, 2025

Related U.S. Application Data
(63) Continuation of application No. PCT/CN2024/090785, filed on Apr. 30, 2024.

(30) Foreign Application Priority Data
May 29, 2023 (CN) 202310621502.5

(51) Int. Cl. H04L 41/0823; H04L 65/65

(52) U.S. Cl. CPC H04L 41/0836; H04L 65/65

(57) ABSTRACT

A network transmission optimization method, apparatus, and computer-readable storage medium for improving data transmission efficiency. The method includes receiving a data stream transmitted between a transmitter and a receiver, identifying key frames within the data stream, and performing statistics collection on these key frames to obtain key frame statistical information. Based on analysis of this statistical information, the system determines whether network optimization is needed for the receiver and performs appropriate network optimization measures when necessary. This approach enables targeted optimization of network performance through focused analysis of critical frames within the transmitted data stream.

### CROSS-REFERENCE TO RELATED APPLICATIONS

This application is a continuation application of International Application No. PCT/CN2024/090785 filed on Apr. 30, 2024 which claims priority to Chinese Patent Application No. 202310621502.5, filed with the China National Intellectual Property Administration on May 29, 2023, the disclosures of each being incorporated by reference herein in their entireties.

### FIELD

The disclosure relates to the field of computer and communication technologies, a network transmission optimization method and apparatus, a storage medium, an electronic device, and a program product.

### BACKGROUND

In the related art, live streaming and streaming media applications become an indispensable part of daily life. These applications may have relatively high requirements on real-time performance and may occupy a relatively large bandwidth. However, network quality may have large impact on stability and user experience of these applications. Users may have increasingly higher demands for live streaming and streaming media applications, and need smoother, clearer, and more stable viewing experience. In addition, live streaming and streaming media applications may have increasingly diverse content, and need a network support with a higher speed and a lower delay. Therefore, how to optimize a network timely and properly to improve network quality is a technical problem that may be resolved urgently.

### SUMMARY

Provided are a network transmission optimization method and apparatus, a device, a storage medium, and a program product, which can implement efficient network optimization based on key frame analysis of data streams.

According to some embodiments, a network transmission optimization method, performed by an electronic device, includes: receiving a data stream transmitted between a transmitter and a receiver; identifying key frames in the data stream; performing statistics collection on the key frames to obtain key frame statistical information; and performing a network optimization for the receiver based on determining, using the key frame statistical information, that network optimization is needed for the receiver.

According to some embodiments, a network transmission optimization apparatus, includes: at least one memory configured to store program code; and at least one processor configured to read the program code and operate as instructed by the program code, the program code including: receiving code configured to cause at least one of the at least one processor to receive a data stream transmitted between a transmitter and a receiver; identifying code configured to cause at least one of the at least one processor to identify key frames in the data stream; statistics code configured to cause at least one of the at least one processor to perform statistics collection on the key frames to obtain key frame statistical information; and optimization code configured to cause at least one of the at least one processor to perform a network optimization for the receiver based on determining, using the key frame statistical information, that network optimization is needed for the receiver.

According to some embodiments, a non-transitory computer-readable storage medium, storing computer code which, when executed by at least one processor, causes the at least one processor to at least: receive a data stream transmitted between a transmitter and a receiver; identify key frames in the data stream; perform statistics collection on the key frames to obtain key frame statistical information; and perform a network optimization for the receiver based on determining, using the key frame statistical information, that network optimization is needed for the receiver.

### BRIEF DESCRIPTION OF THE DRAWINGS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

FIG. 1 is a schematic diagram of an exemplary implementation environment according to some embodiments.

FIG. 2 is a schematic diagram of an exemplary implementation environment according to some embodiments.

FIG. 3 is a schematic diagram of an exemplary implementation environment according to some embodiments.

FIG. 4 is a flowchart of a network transmission optimization method according to some embodiments.

FIG. 5 is a flowchart of a network transmission optimization method according to some embodiments.

FIG. 6 is a schematic diagram of a network optimization process according to some embodiments.

FIG. 7 is a schematic functional diagram included in a user plane function (UPF) according to some embodiments.

FIG. 8 is a schematic diagram of function description of a UPF according to some embodiments.

FIG. 9 is a schematic diagram of a network test environment according to some embodiments.

FIG. 10 is a schematic diagram of a network test process according to some embodiments.

FIG. 11 is a block diagram of a network transmission optimization apparatus according to some embodiments.

FIG. 12 is a schematic structural diagram of a computer system of an electronic device configured to implement some embodiments.

### DESCRIPTION OF EMBODIMENTS

Exemplary implementations are described more comprehensively with reference to drawings. However, the exemplary implementations may be implemented in various forms, and cannot be construed as being limited to these examples. Rather, the implementations are provided to make the disclosure more comprehensive and complete, and to comprehensively convey the idea of the exemplary implementations to a person skilled in the art.

In addition, features, structures, or characteristics described in the disclosure may be combined in one or more embodiments in any proper manner. In the following description, many details are provided to comprehensively understand some embodiments. However, a person skilled in the art is to be aware that, during implementation of the technical solutions in the disclosure, not all detailed features in some embodiments may be used, one or more details may be omitted, or another method, unit, apparatus, operation, and the like may be used.

The block diagrams shown in the drawings are merely functional entities and do not necessarily correspond to physically independent entities. The functional entities may be implemented in a form of software, or in one or more hardware modules or integrated circuits, or in different networks and/or processor apparatuses and/or microcontroller apparatuses.

The flowcharts shown in the drawings are merely exemplary descriptions, and neither necessarily may include all content and operations, nor necessarily may be performed in the described order. For example, some operations/steps may be further divided, while some operations/steps may be merged or partially merged. Therefore, an actual execution order may change according to an actual case.

“A plurality of” mentioned herein means two or more. “And/or” describes an association relationship between associated objects, and indicates that three relationships may exist. For example, A and/or B may represent that: only A exists, both A and B exist, and only B exists. The character “/” generally indicates an “or” relationship between a preceding associated object and a succeeding associated object.

First, in the disclosure, a prompt interface or a pop-up window may be displayed before and during collection of relevant data (such as a data stream transmitted by a transmitter to a receiver). The prompt interface or the pop-up window is configured for prompting a user that the relevant data is currently being collected. Therefore, in the disclosure, so that in the disclosure, the relevant operation of obtaining the relevant data is started only after a confirmation operation performed by the user on the prompt interface or the pop-up window is obtained. Otherwise (i.e., when the confirmation operation performed by the user on the prompt interface or the pop-up window is not obtained), the operation of obtaining the relevant data is ended, i.e., the relevant data is not obtained. In other words, some embodiments involves relevant data such as data streams. When the foregoing embodiment of the disclosure is applied to a product or technology, a user permission or consent may be obtained, and collection, use, and processing of the relevant data may comply with relevant laws, regulations, and standards of relevant countries and regions.

Then technical terms appearing in some embodiments are described

5G core (5GC) network: It is a core part in a 5G communication system, which is responsible for data transmission and control in a mobile communication network and providing a higher data transmission rate, a lower delay, and a higher network capacity, to support more user and device connections. The 5GC network adopts a hierarchical architecture, including two parts: a user plane and a control plane. The user plane is responsible for data transmission, including data encryption, decryption, and transmission. The control plane is responsible for network control and management, including user identity verification, session management, and resource allocation.

Video push/pull stream: A push stream refers to a process of transmitting a video from a source (which is usually a camera or a video capturing device) to a streaming media server. A pull stream refers to a process of obtaining a video from a streaming media server and displaying the video on a terminal device (which is usually a computer or a mobile device).

User plane function (UPF): It refers to a network function responsible for user data transmission in a 5G network. The UPF may distribute user data traffic to different network nodes, so as to implement various service demands in a network, for example, in provide a low-delay and high-bandwidth network service, so as to implement flexible network configuration and efficient data transmission and management, and bring higher network quality and user experience to various service scenarios. Application scenarios of UPF include enhanced mobile broadband (eMBB), Internet of things (IoT), and intelligent manufacturing (industry 4.0).

The eMBB is a most fundamental service demand in the 5G network, and includes application scenarios such as a high-definition video, virtual reality (VR), and augmented reality (AR). A UPF in a software defined network (SDN) may transmit user data to a proper network node, so as to quickly respond to a service demand of a mobile user and implement low-delay and high-bandwidth data transmission.

The IoT refers to connecting various devices and articles through the Internet, to implement collection and transmission of data. The UPF in the SDN can implement flexible network configuration, distribute data transmission of various devices and articles to different network nodes, and implement efficient data transmission and management.

The intelligent manufacturing refers to implementing digitalization and intelligentization of the manufacturing industry by using Internet and digital technologies, including data collection and transmission of various devices and systems. The UPF in the SDN can implement network management and optimization for various devices and systems in intelligent manufacturing, to improve manufacturing efficiency and product quality.

Real-time transport control protocol (RTP): It may be configured for transmitting a voice, a video, and other multimedia data. The RTP is very suitable for real-time multimedia applications, such as live streaming, voice of internet phone, and video conferencing.

H.264 protocol: It is a video encoding/decoding protocol, which is also referred to as an advanced video coding (AVC) protocol, and is a standard configured for digital video compression. The H.264 encoding/decoding protocol adopts an advanced compression technology, which can compress a video to a relatively small file size while maintaining high quality. In an H.264 encoding process, a video frame is divided into a plurality of small blocks, and each small block is encoded into an independent data unit, which is referred to as a network abstraction layer unit (NALU). The NALU is a unit of an H.264 bit stream, and includes header information of video data and actual video data. An H.264 bit stream is divided into two layers: a video coding layer (VCL) and a network abstraction layer (NAL). The VCL is responsible for video compression and encoding, and the NAL is responsible for packaging data generated by the VCL into a NALU and adding header information for transmission and decoding.

Video frame: It is a concept in video encoding, which may be classified into an I frame, a B frame, and a P frame. The I frame is also referred to as an independent frame or a key frame, and may be independently encoded without relying on information of another frame. Therefore, the I frame has a largest amount of data, and can provide relatively good image quality, which helps recover a complete structure of a video picture during video encoding. The B frame is referred to as a bidirectional frame, and is decoded by using a previous I or P frame and a subsequent P frame as reference information. The B frame has a smaller amount of data than the I frame and the P frame, which can improve a compression effect of a video. The P frame is referred to as a predicted frame, and is decoded based on information of a previous key frame. The P frame may be configured for improving video compression efficiency and reduce a volume of to-be-transmitted data.

Vector packet processing framework (VPP framework): It is an extensible open-source framework, which provides a production quality switch/router function. The VPP has two main functions: framework extension and mature switching/routing. The VPP platform is intended to solve a high-delay problem existing in processing of a single data packet in a scalar processing method. To improve network extensibility, the VPP adopts a vector processing manner, so that a plurality of data packets can be processed simultaneously, reducing a delay. The VPP may provide a function of a network switch or a router, and may be used in scenarios including a data center, cloud computing, edge computing, the IoT, and the like. In addition, the flexibility and extensibility of the VPP also provide possibilities for fields such as network security and virtualized networks.

Data plane development kit (DPDK): It is an open-source data plane development kit, which provides a set of libraries and drivers that can help developers quickly construct a high-performance data plane application. The DPDK may be used in fields such as network functions virtualization (NFV) and a software defined network (SDN), and can accelerate data packet processing and forwarding and improve performance and a throughput of a network application program.

Adaptive bitrate algorithm: It means dynamically adjusting a video bitrate based on factors such as a current network condition and device performance, to ensure smooth playback of a video. The ABR algorithm is an adaptive bitrate algorithm. The ABR algorithm is a video streaming media transmission algorithm based on bitrate adaptation, which constantly monitors factors such as a network condition and device performance to dynamically adjust a video bitrate, to ensure smooth playback of a video. A core idea of the ABR algorithm is switching between different bitrates, to adapt to different network conditions. When the network condition is relatively good, the ABR algorithm selects a relatively high bitrate for transmission, to improve a definition of a video. When the network condition is relatively poor, the ABR algorithm selects a relatively low bitrate for transmission, to ensure smooth playback of a video. In an actual application, the ABR algorithm usually selects a bitrate by using some heuristic policies, such as buffer-based ABR and rate-based ABR. The buffer-based ABR algorithm selects a bitrate based on a padding status of a current buffer, to avoid the buffer from overflowing or falling excessively fast. The rate-based ABR algorithm selects a bitrate based on factors such as a current network condition and device performance, to ensure smooth playback of a video.

Then an application environment of some embodiments is described. The technical solutions of some embodiments may be applied to scenarios having relatively high requirements on real-time quality and a bandwidth, such as live streaming and streaming media applications. However, network quality has large impact on stability and user experience of these applications. Users have increasingly higher demands for live streaming and streaming media applications, and need more smooth, clear, and stable viewing experience. In addition, live streaming and streaming media applications have increasingly diversified content, and need a network support with a higher speed and a lower delay.

In view of the foregoing problem, some embodiments provides a new network transmission optimization solution. Identification and statistics collection may be performed on a data stream in a data transmission channel between a transmitter and a receiver (e.g. a data transmitter and a data receiver), to determine a key frame transmission status decisive for recovery of the data stream, so as to timely determine whether network optimization may be performed, thereby ensuring that the data receiver can smoothly receive and recover the data stream transmitted by the data transmitter, which helps improve network transmission quality.

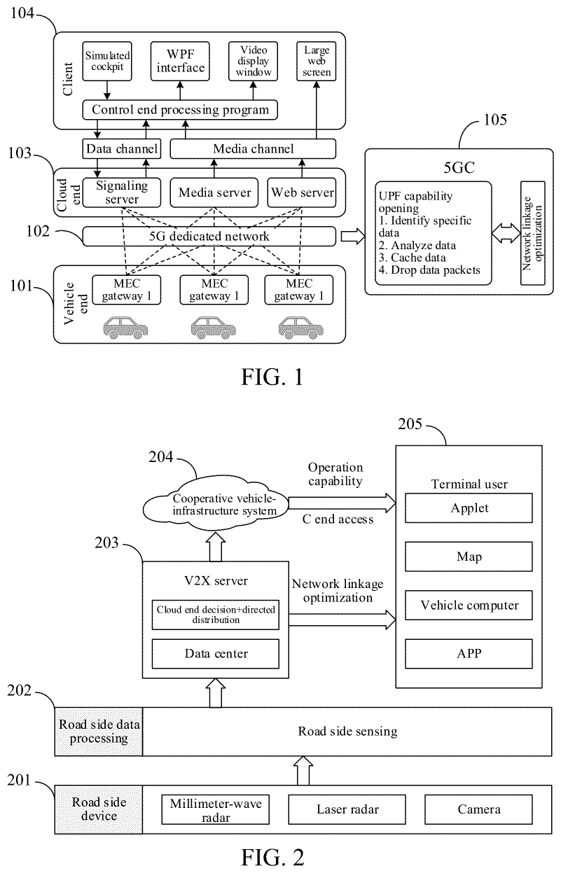

In an application scenario of the disclosure, for example, a remote driving system based on a 5G network shown in FIG. 1, a camera of a vehicle end 101 transmits video stream data through a mobile edge computing (MEC) gateway 1 and a 5G dedicated network 102. After reaching a cloud end 103, the video stream data is processed by a signaling server, a media server, and a web server, and then corresponding data may be transmitted to a client 104 such as a simulated cockpit, a windows presentation foundation (WPF) interface, a video presentation window, and a large web screen through a data channel and a media channel for display and playback.

Based on the technical solutions of some embodiments, in a 5GC 105 of the 5G dedicated network, the UPF may identify data (for example, key frame data) in a video stream through a capability opening technology, perform data caching and analysis, to determine current network quality, and perform network linkage optimization in combination with user bandwidth allocation or the adaptive bitrate algorithm when determining that the network quality is relatively poor, so as to optimize a transmission process of the data, and prevent phenomena such as freezing and screen flickering during video playback on a user side.

In addition, the UPF may further perform data packet dropping through the capability opening technology. For example, a key frame in a video stream is dropped, so that a case in which a network is relatively poor may be simulated, so as to verify a capability of a client to deal with a weak network environment.

FIG. 2 is a schematic diagram of application of the technical solutions of some embodiments to a cooperative vehicle-infrastructure system. A road side device 201, such as a millimeter-wave radar, a laser radar, or a camera, is configured to collect data such as a road side image. The collected data is subjected to road side processing 202, and then is transmitted to a vehicle to everything (V2X) service 203, and then is transmitted to a terminal user 205 (such as an applet, a map application, a vehicle computer, or an APP) through a cooperative vehicle-infrastructure system 204 and through the 5GC network.

In the application scenario, the transmitted data can also be effectively transmitted to the terminal user through the network linkage optimization. The UPF in the 5G system may identify data (for example, key frame data) in transmitted data through the capability opening technology, perform data caching and analysis, to determine current network quality, and perform network linkage optimization in combination with user bandwidth allocation or the adaptive bitrate algorithm when determining that the network quality is relatively poor.

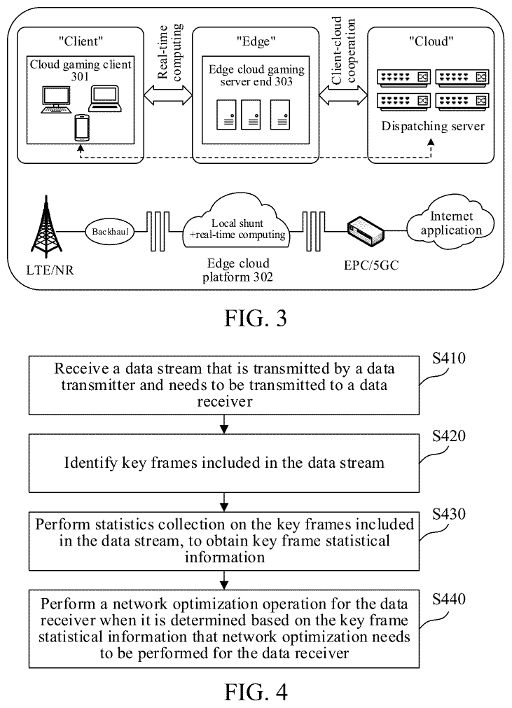

FIG. 3 is a schematic diagram of application of the technical solutions of some embodiments to a cloud gaming scenario. Cloud gaming is also referred to as gaming on demand, and is an online gaming technology based on the cloud computing technology. The cloud gaming technology enables a thin client with relatively limited graphics processing and data computing capabilities to run a high-quality game. In the cloud gaming scenario, a game is run on a cloud server rather than a game terminal of a player, and the cloud server renders the game scenario into a video/audio stream, and transmits the video/audio stream to the game terminal of the player through a network. The game terminal of the player may not be required to have powerful graphics computing and data processing capabilities, and may only be required to have a streaming media playback capability and a capability of obtaining instructions inputted by the player and transmitting the instructions to the cloud server.

Referring to FIG. 3, in the cloud gaming scenario, a cloud gaming client 301 communicates with an edge cloud gaming server end 303 in an edge cloud platform 302 through long term evolution (LTE)/new radio (NR, for example, a radio access network of a 5G system), and the edge cloud platform 302 connects to an evolved packet core (EPC, i.e. a 4G core network)/5GC and then cooperatively communicates with an Internet application in a cloud. After the technical solutions of some embodiments are applied, for service data transmission in the cloud gaming scenario, data transmission optimization may be performed when network quality degrades or data increases significantly in a short time, to prevent problems such as freezing and data corruption during data receiving and rendering by the terminal user.

It may be learned that, in the technical solutions of some embodiments, optimization may be performed on a network in any scenario, so as to timely and properly determine whether network optimization may be performed, and take a corresponding network optimization means when network optimization may be performed, which helps improve network transmission quality.

In some embodiments, a device used by the terminal user may be a smartphone, a tablet computer, a notebook computer, a desktop computer, a smart speaker, a smartwatch, an on-board terminal, a smart television, an aircraft, or the like, but is not limited thereto. The server mentioned in some embodiments may be an independent physical server, or may be a server cluster or a distributed system composed of a plurality of physical servers, or may be a cloud server providing a cloud computing service.

Implementation details of the technical solutions of some embodiments are described in detail below.

FIG. 4 is a flowchart of a network transmission optimization method according to some embodiments. The network transmission optimization method may be performed by a network device. The network device may be, for example, an access network device (such as a base station), a core network device (such as a UPF), or a MEC server connected to the UPF. Referring to FIG. 4, the network transmission optimization method includes at least operation S410 to operation S440. A detailed description is as follows:

Operation S410: Receive a data stream that is transmitted by a data transmitter and may be transmitted to a data receiver.

In some embodiments, the data transmitter and the data receiver are respectively a transmitter and a receiver of data. For example, the data transmitter may be a terminal device running a game client, and the data receiver may be a game server. In this case, game data transmitted by the terminal device is transmitted to the game server through an access network and a core network. In some embodiments, the data transmitter may be a game server, and the data receiver may be a terminal device running the game client. In this case, the game data transmitted by the game server is transmitted to the terminal device through the core network and the access network.

Because the data transmission between the data transmitter and the data receiver may pass through the access network and the core network, the data stream that is transmitted by the data transmitter and may be transmitted to the data receiver may be received by a network device on a transmission path between the data transmitter and the data receiver. For example, the data stream that is transmitted by the data transmitter and may be transmitted to the data receiver may be received by the UPF, or the data stream that is transmitted by the data transmitter and may be transmitted to the data receiver may be received by the base station. In another embodiment of the disclosure, the data stream that is transmitted by the data transmitter and may be transmitted to the data receiver may be received by another device. For example, the data stream that is transmitted by the data transmitter and may be transmitted to the data receiver may be received by the MEC server connected to the UPF.

Operation S420: Identify key frames included in the data stream.

In some embodiments, a type of a data frame included in the data stream, i.e., whether the data frame is a key frame, may be identified based on a feature of the data frame.

During key frame identification, data packets in the data stream may be captured, features of the captured data packets are extracted, and then the features of the captured data packets are compared with a feature of a key frame data packet, to identify the key frames included in the data stream.

In some embodiments, comparison may be performed based on at least one of the following data packet features, to identify the key frames included in the data stream: a protocol field in an Internet protocol (IP) header, a version field in a real-time transport control protocol (RTP) layer, a padding field in the RTP layer, an extension field in the RTP layer, a marker field in the RTP layer, and a NALU type field (i.e., a Nal_unit_type field).

In some embodiments, the key frames included in the data stream may be identified through the foregoing field. This may be because during transmission of the key frames based on a user datagram protocol (UDP), a protocol field value in the IP header of a key frame is 17, the version field in the RTP layer is RFC 1889 Version, the padding field, the extension field, and the maker field are all False, and Nal_unit_type in the H.264 layer is equal to 5. Therefore, the key frames included in the data stream may be identified based on the foregoing fields.

In some embodiments, when the key frames are split into a plurality of data packets for transmission, data packets belonging to the same key frame may be identified based on values of specified fields included in the captured data packets. Each of the specified field includes a start bit (for example, start_bit) and an end bit (for example, end_bit) in an encoding protocol layer. A start bit of the first data packet in the plurality of data packets is a second value, and an end bit is a first value. A start bit of the last data packet in the plurality of data packets is a second value, and an end bit is a first value. Start bits and end bits in data packets in the plurality of data packets other than the first data packet and the last data packet are second values. In some embodiments, the first value may be 1, and the second value may be 0.

In some embodiments, after the key frames included in the data stream are identified, the identified key frames may be stored. When the key frames are split into a plurality of data packets for transmission, the identified key frames are stored through a key-value pair by using RTP. Timestamps of the key frames as a key and the plurality of data packets as a value.

In some embodiments, the identified key frames may be stored through a hash table. In this case, a storage space size set for the hash table may be received, and then a latest received key frame is stored in a queue based on the storage space size. In some embodiments, a newly received key frame is stored in a queue, but because the storage space size is limited, a previously received key frame may be deleted, so that a quantity of key frames stored in the queue matches the set storage space size.

Operation S430: Perform statistics collection on the key frames included in the data stream, to obtain key frame statistical information.

In some embodiments, a quantity of current to-be-transmitted key frames may be counted, or a growth rate of to-be-transmitted key frames within a unit time may be calculated, which is used as the key frame statistical information.

Operation S440: Perform a network optimization operation for the data receiver when it is determined based on the key frame statistical information that network optimization may be performed for the data receiver.

In some embodiments, it is determined that network optimization may be performed for the data receiver when it is determined that a quantity of current to-be-transmitted key frames is greater than or equal to a first quantity threshold based on the key frame statistical information; If the quantity of to-be-transmitted key frames is relatively large, it indicates that network congestion may occur. Therefore, it may be determined that network optimization may be performed.

In some embodiments, it is determined that network optimization may be performed for the data receiver when it is determined that a growth rate of to-be-transmitted key frames within a unit time is greater than or equal to a set growth rate threshold based on the key frame statistical information. If the growth rate of the to-be-transmitted key frames within the unit time is relatively large, it indicates that a video bitrate corresponding to the data stream or a video picture switching frequency is relatively high and increased transmission pressure is caused. Therefore, it may be determined that network optimization may be performed.

In some embodiments, it is determined that network optimization may be performed for the data receiver when it is determined based on the key frame statistical information that the growth rate of to-be-transmitted key frames within the unit time is greater than or equal to the set growth rate threshold and that a group of pictures (GOP) length of the data stream is less than or equal to a set length threshold. If the growth rate of the to-be-transmitted key frames within the unit time is relatively large and a GOP is relatively long, it indicates that the video bitrate corresponding to the data stream is relatively high and increased transmission pressure is caused. Therefore, it may be determined that network optimization may be performed.

In some embodiments, if a quantity of key frame retransmission requests received within the unit time is greater than or equal to a second quantity threshold, it may also indicate that network congestion occurs and a relatively large quantity of packet losses are caused. Therefore, it may also be determined that network optimization may be performed for the data receiver.

In some embodiments, the network optimization performed for the data receiver may be reducing a transmission bitrate of the data stream or increasing a network bandwidth for the data receiver.

In some embodiments, the network optimization may be performed adaptively through machine learning. For example, when it is determined that network optimization may be performed for the data receiver, a network feature between the data transmitter and the data receiver and a service feature corresponding to the data stream are obtained, and then an input parameter of a pre-trained network optimization model is generated based on the network feature and the service feature. The pre-trained network optimization model is obtained through training by using a network feature sample and a service feature sample. The input parameter is inputted into the pre-trained network optimization model, and a network optimization parameter is outputted, so as to perform the network optimization for the data receiver based on the network optimization parameter.

In some embodiments, the network feature between the data transmitter and the data receiver may be a network state parameter, such as a packet loss rate, a received signal strength indicator (RSSI), or a reference signal receiving power (RSRP). The service feature corresponding to the data stream may include a bandwidth requirement of the service, a delay requirement of the service, and the like. The network optimization model may be a convolutional neural network (CNN) model, a recurrent neural network (RNN) model, or the like.

In some embodiments, during generation of the input parameter of the pre-trained network optimization model based on the network feature and the service feature, cascade processing may be performed on the network feature and the service feature, to obtain the input parameter of the network optimization model.

In some embodiments, in the technical solution of some embodiments, after the key frames included in the data stream are identified, a pre-determined quantity of key frames may be dropped based on a set dropping policy, and then a quantity of received key frame retransmission requests is counted, to determine network quality simulated through key frame dropping based on the counted quantity of key frame retransmission requests. In other words, in this embodiment, the key frame may be dropped to simulate network quality.

In some embodiments, a network simulation configuration item may be set for the network simulation function may be configured, and then the network simulation function is enabled or disabled based the network simulation configuration item. A trigger operation performed on the network simulation configuration item may be received. The operation of dropping a predetermined quantity of key frames based on the set dropping policy is performed when the trigger operation is configured for enabling a network simulation function. The key frame dropping process is stopped when the trigger operation is configured for disabling the network simulation function.

It may be learned based on the technical solution of some embodiments shown in FIG. 4 that, in the disclosure, through the identification and statistics collection on the key frames in the data stream, it may be timely and properly determined whether network optimization may be performed, and a corresponding network optimization means may be taken when network optimization may be performed, which helps improve network transmission quality.

Implementation details of the technical solution of some embodiments are described in detail below by using performing the network optimization based on the UPF capability opening technology as an example.

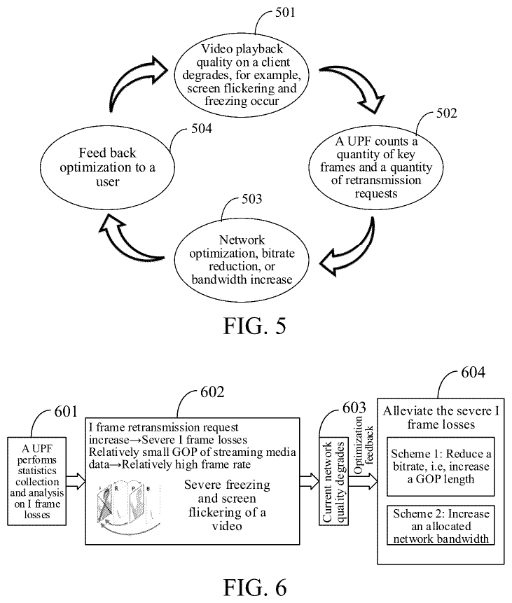

As shown in FIG. 5, in 501, it is assumed that currently network congestion occurs, which results in degrading network quality and packet losses during data stream transmission, resulting in video playback quality degradation on a client, for example, phenomena such as freezing and screen flickering occur.

In 502, after the UPF capability opening function in some embodiments is introduced, the UPF identifies video key frames, counts a quantity of key frames and a quantity of key frame retransmission requests, and then determines whether a problem of network quality degradation occurs based on the counted quantity of key frames and the counted quantity of key frame retransmission requests.

The determining has the following two cases:
1. If the quantity of key frame retransmission requests within a unit time increases, it indicates that the network quality actually degrades, resulting in a relatively large quantity of packet losses in a network.
2. If the quantity of key frames within the unit time sharply increases but a GOP is relatively small, it indicates that a bandwidth demand of a user increases. In this case, network optimization may be performed to avoid network congestion.

In 503, after it is determined that network optimization may be performed, the network optimization may be performed through a fast linkage mechanism. In some embodiments, the following two optimization methods may be used:
1. A bandwidth of a user is improved through the UPF or a base station. In this case, even if a current key frame data transmission demand of the user sharply increases, smooth data transmission can be ensured through network bandwidth adjustment.
2. Optimization is performed in combination with an adaptive bitrate algorithm, for example, an ABR algorithm. In this case, even if network congestion or another problem regarding quality degradation occurs, a bitrate for transmission may be reduced, to avoid a freezing phenomenon during playback on a user terminal.

After the network optimization is performed, in 504, the optimization may be fed back to the user terminal, to improve the video playback quality on the terminal.

The key frame in some embodiments may be an I frame, or may be an instantaneous decoder refresh (IDR) frame. A description is further provided below by using an example that the key frame is an I frame.

FIG. 6 is a schematic diagram of a network optimization process according to some embodiments. Details are as follows:

In 601, a related function may be developed in a UPF network element in a 5GC network to perform identification, statistics collection, and caching on I frames, and analyze an I frame data amount within a unit time and a loss status of the I frames, so as to determine current network quality in 602. For example, if a quantity of I frame retransmission requests increases, it indicates that severe I frame losses occur. If a GOP of the streaming media data is relatively small, it indicates that a frame rate is relatively high, resulting in phenomena such as severe freezing and screen flickering of a video.

In 603, when the UPF detects that the current network quality degrades and therefore cannot deal with a sharply increased data transmission amount of the I frames or alleviate the severe I frame losses, an optimization measure may be immediately initiated in 604. For example, to alleviate the severe I frame losses, a bitrate may be reduced based on the ABR algorithm, i.e., a GOP length is increased, or an allocated network bandwidth is increased, so as to optimize the video playback quality on the client.

Based on the technical solutions of some embodiments, the UPF in some embodiments may have the following functional modules:
1. an I frame data detection function;
2. an I frame data statistics collection function;
3. an I frame data storage function; and
4. an I frame data packet dropping function, to simulate network quality through packet loss dropping.

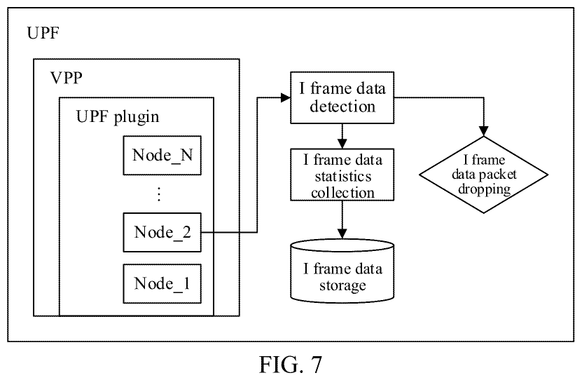

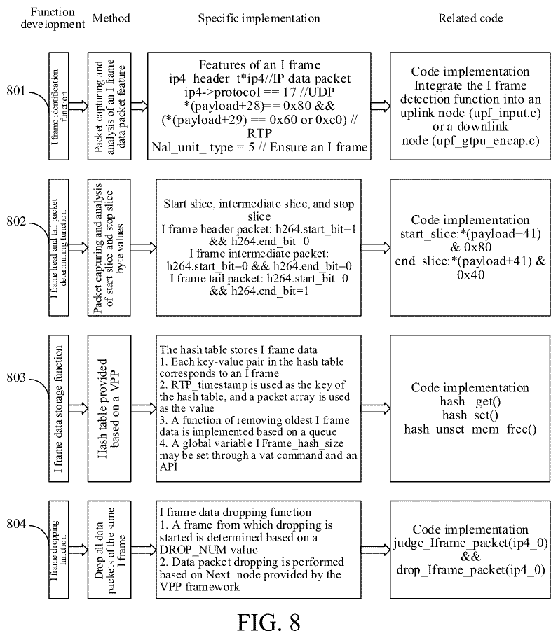

In some embodiments, the UPF may be developed with the help of a DPDK technology and a VPP framework, which only requires to gather these functional modules into a node in the VPP. In some embodiments, these functions may be integrated on both uplink and downlink nodes of the UPF. Therefore, the I frame data may be identified, analyzed, and cached in all directions (i.e., uplink and downlink). Functions implemented by the UPF functional module are shown in FIG. 7, i.e., the four functions mentioned above. The functions defined by the UPF in some embodiments are respectively described below in detail with reference to FIG. 8.

The I frame data detection function is configured to identify the I frames in the data stream, which is an I frame identification function 801 shown in FIG. 8.

The I frame identification function 801 may perform packet capturing and packet analysis based on a packet capturing tool (such as wireshark), to obtain a feature of an I frame data packet. After a comparison experiment of sufficient captured packets and a reference to an RFC standard, it is determined that the I frame data packet transmitted based on the UDP protocol have the following features in some embodiments: a protocol field value in an IP header is 17, a version field in an RTP layer is RFC 1889 Version, a padding field, an extension field, and a maker field are all False, and Nal_unit_type in an H.264 layer of the I frame is equal to 5, indicating that the packet is an encoded slice of an IDR image. Therefore, for the features of the I frame data obtained based on the foregoing features, a corresponding identification function may be developed in the uplink and the downlink nodes of the UPF during code implementation, and IDR data passing through the UPF is stored in a hash table.

The I frame data detection function may further include an I frame head and tail packet determining function 802 shown in FIG. 8. Because an I frame may be split into a plurality of IP data packets for network transmission, an I frame may be determined by identifying IP data packets at a frame head and a frame tail. Similarly, in some embodiments, the function may be developed based on wireshark packet capturing and analysis and an RFC standard document. A feature of a head packet of the I frame is: a start_bit field of the H.264 layer is 1. A feature of a tail packet of the I frame is: an end_bit field of the H.264 layer is 1. A feature of an intermediate packet of the I frame is: start_bit and end_bit of the H.264 layer are both 0.

The I frame data statistics collection function is to count a data amount of the I frame within a unit time and a quantity of received retransmission requests of the I frame, so as to subsequently determine whether network optimization may be performed.

The I frame data storage function 803 is to cache an identified I frame in a hash table for storage in the UPF. An RTP. Timestamp of the I frame is used as a key of the hash table, and a group of packets (i.e., the plurality of IP data packets obtained by splitting the I frame) is used as a value of the hash table. In addition, to reduce internal memory overheads, a function of removing oldest I frame data may be implemented based on a queue. In addition, a global variable I Frame_hash_size, i.e., a hash table size configured for storing the I frame, may be set through a vat command and an application programming interface (API). During the code implementation, hash_get( ) is configured for reading the I frame data in the hash table, hash_set( ) is configured for storing the data in the hash table, and hash_unset_mem_free( ) is configured for releasing older I frame data stored in the hash table.

The I frame dropping function 804 is developed to simulate a weak network environment. A packet is actively dropped in the UPF to simulate a packet loss phenomenon in a real network environment. For example, an I frame from which packet dropping is started is determined from based on a value of DROP_NUM (which is a preset parameter). After the packet dropping, the video playback on the client is seriously affected, and phenomena such as screen flickering and freezing occur. Then, the client actively transmits an I frame data retransmission packet to re-request the I frame data to recover the video playback. Therefore, the UPF may further determine the network quality by counting I frame retransmission packets. In some embodiments, the function may be enabled or disabled through a configuration item.

Based on each functional module in the UPF capability opening shown in FIG. 7 and FIG. 8, in the technical solutions of some embodiments, real-time statistics collection and analysis of I frame data may be implemented, and after it is determined that the current network quality degrades, network linkage optimization may be performed. For example, the bandwidth is increased or optimization and adjustment feedback are performed through the ABR algorithm, so as to ensure fluency of the video playback on the client.

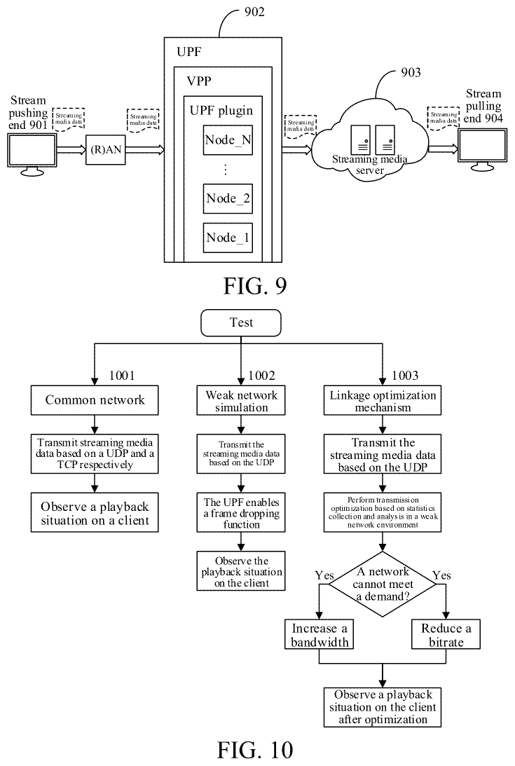

In some embodiments, FIG. 9 is a schematic diagram of a network test environment according to some embodiments. To simulate a streaming media transmission scenario such as live streaming, in some embodiments, an ffmpeg tool (which is an open-source computer program that may be configured to record digital audios and videos and convert the digital audios and videos into a stream) and an ffplay tool (which is an audio/video media player provided by ffmpeg) may be used to perform video stream push-pull.

As shown in FIG. 9, a stream pushing end 901 pushes streaming media data based on a radio access network (RAN), and the streaming media data is transmitted through the 5GC network 902. Therefore, real-time statistics collection and analysis are performed on all transmitted I information through the capability opening function in the UPF. Then, the streaming media data flows out through an N6 port of the UPF, and is transmitted to the streaming media server 903. Then, a stream pulling end 904 pulls the streaming media data from the streaming media server 903 to a local place for playback.

Based on the test environment shown in FIG. 9, as shown in FIG. 10, a network environment test scenario according to some embodiments includes a network scenario 1001, a weak network simulation scenario 1002, and a linkage optimization mechanism scenario 1003 in some embodiments.

In the network scenario 1001, the streaming media data may be transmitted based on the UDP and a transmission control protocol (TCP) respectively, i.e., real-time statistics collection and analysis and the linkage optimization mechanism of the UPF in some embodiments are not introduced, and stream pull and video playback on the client are observed.

The weak network simulation scenario 1002 means simulating transmission of streaming media data based on the UDP protocol in an environment with network congestion and a relatively high packet loss rate, without introducing the real-time statistics collection and analysis and the linkage optimization mechanism of the UPF in some embodiments. To create a weak network environment, in some embodiments, a network packet loss is simulated based on the I frame dropping function in the UPF capability opening technology, so that the client cannot receive the transmitted streaming media data normally.

The linkage optimization mechanism scenario 1003 means introducing the real-time statistics collection and analysis and the linkage optimization mechanism of the UPF provided in some embodiments into the weak network environment and then transmitting the streaming media data based on the UDP protocol. During the data transmission, the UPF performs statistics collection, analysis, and caching on all I frame data passing through the 5GC network, and initiates the linkage optimization mechanism to optimize the data transmission when determining that an I frame transmission demand in the current network is relatively large or I frame retransmission packets transmitted by the client increase, i.e., the network cannot satisfy the demand.

An optimization method may be divided into two aspects:
1. A bandwidth is improved. The UPF detects that a current I frame data transmission amount increases, or a quantity of I frame retransmission packets transmitted by the client increases, i.e., network congestion may occur and network packet losses are caused. Therefore, a bandwidth allocated to a user may be increased to ensure transmission quality of data.
2. If the UPF detects, through statistics collection, that a quantity of I frames within a unit time is relatively large, a video playback bitrate on the client may be relatively high or an image switching frequency is relatively high. Therefore, the I frame data transmission amount may be reduced by reducing video bitrate.

After a test is performed, it is found that in a network environment, when data transmission of streaming media is performed based on the TCP protocol, a playback effect on the client is relatively good. However, when the data transmission of streaming media is performed based on the UDP protocol, phenomena such as screen flickering and freezing occur during the client playback. According to an experiment, the phenomena are due to network packet losses caused by reliability of the UDP protocol. However, in most applications, because transmission efficiency and delay performance of the UDP are better than those of the TCP protocol, the UDP protocol is used for data transmission.

To ensure availability of the technical solutions in some embodiments, in some embodiments, a test experiment is performed mainly based on the UDP protocol. In the weak network environment, because constant network packet losses occur to the I frame, a playback situation on the client is extremely poor, which almost has no complete image. However, in the third test environment, i.e., after the real-time statistics collection and analysis and the linkage optimization mechanism of the UPF are introduced, the data transmission has an adaptive capability. Even in the weak network environment, the network may be adjusted by analyzing the I frame data transmission amount within the unit time in real time, thereby ensuring video playback quality on the client.

Based on the above, the technical solutions in some embodiments are oriented to the multimedia data transmission scenario based on the 5GC network, and provide the data transmission solution based on the UPF capability opening technology and the network linkage feedback mechanism, to ensure smooth transmission of the streaming media data, improve video playback quality on the client, and more effectively support product items such as real-time digital twin, 5G remote driving, and the industrial Internet. Compared with the related art, some embodiments have the following advantages: cost overheads of hardware are reduced, and the UPF capability opening technology is combined with the functions of I frame data statistics collection, identification, and caching for the first time. The entire mechanism that is provided provides reference and application values in the field of 5G communication networks.

In addition, the architecture provided in some embodiments may be divided into two modules, for example, statistics collection and analysis and optimization feedback. The two modules both have a high expansion capability. In the UPF, the statistics collection and analysis functional module mainly performs identification, statistics collection and analysis, and caching on the I frames of the streaming media data, and the module may be further expanded to perform statistics analysis on other data (such as a B frame or a P frame).

Similarly, in the technical solutions of some embodiments, in the optimization feedback operation, the solution of increasing a user bandwidth and performing optimization based on the adaptive bitrate algorithm is used. However, in another embodiment of the disclosure, a reinforcement learning or dynamic adaptation method may be introduced for further optimization. In addition, in another embodiment of the disclosure, a congestion avoidance and control algorithm may be introduced to reduce a probability of network congestion, and a more robust routing mechanism may be introduced so that the client can receive and transmit the data smoothly.

An apparatus embodiment of the disclosure is described below, which may be configured for performing the network transmission optimization method in the foregoing embodiments of the disclosure. For details not disclosed in the apparatus embodiment of the disclosure, reference is made to the foregoing embodiments of the network transmission optimization method in the disclosure.

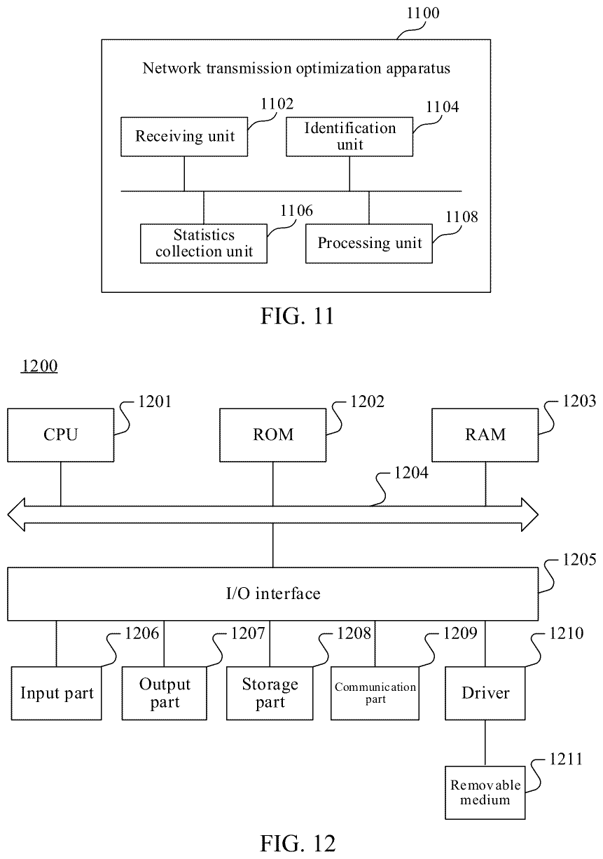

FIG. 11 is a block diagram of a network transmission optimization apparatus according to some embodiments. The network transmission optimization apparatus may be applied to a network device. The network device may be, for example, an access network device (such as a base station), a core network device (such as a UPF), or a MEC server connected to the UPF.

With reference to FIG. 11, a network transmission optimization apparatus 1100 according to some embodiments includes a receiving unit 1102, an identification unit 1104, a statistics collection unit 1106, and a processing unit 1108.

The receiving unit 1102 is configured to receive a data stream that is transmitted by a data transmitter and may be transmitted to a data receiver.

The identification unit 1104 is configured to identify key frames included in the data stream.

The statistics collection unit 1106 is configured to perform statistics collection on the key frames, to obtain key frame statistical information.

The processing unit 1108 is configured to perform a network optimization operation for the data receiver when it is determined based on the key frame statistical information that network optimization may be performed for the data receiver.

In some embodiments of the disclosure, based on the foregoing solutions, the processing unit 1108 is configured to determine, in at least one of the following manners, that network optimization may be performed for the data receiver:
determining that network optimization may be performed for the data receiver when it is determined that a quantity of current to-be-transmitted key frames is greater than or equal to a first quantity threshold based on the key frame statistical information;
determining that network optimization may be performed for the data receiver when it is determined that a growth rate of to-be-transmitted key frames within a unit time is greater than or equal to a set growth rate threshold based on the key frame statistical information; and
determining that network optimization may be performed for the data receiver when it is determined based on the key frame statistical information that the growth rate of to-be-transmitted key frames within the unit time is greater than or equal to the set growth rate threshold and that a GOP length of the data stream is less than or equal to a set length threshold.

In some embodiments of the disclosure, based on the foregoing solutions, the processing unit 1108 is further configured to: determine that network optimization may be performed for the data receiver when a quantity of key frame retransmission requests received within the unit time is greater than or equal to a second quantity threshold.

In some embodiments of the disclosure, based on the foregoing solutions, the identification unit 1104 is configured to: capture data packets in the data stream, and extracting features of the captured data packets; and compare the features of the captured data packets with a feature of a key frame data packet, to identify the key frames included in the data stream.

In some embodiments of the disclosure, based on the foregoing solutions, the identification unit 1104 is configured to: perform comparison with at least one of the following data packet features, to identify the key frames included in the data stream: a protocol field in an IP header, a version field in an RTP layer, a padding field in the RTP layer, an extension field in the RTP layer, a marker field in the RTP layer, and a NALU type field.

In some embodiments of the disclosure, based on the foregoing solutions, the identification unit 1104 is further configured to: identify, when the key frames are split into a plurality of data packets for transmission, data packets belonging to the same key frame based on values of specified fields included in the captured data packets,
each of the specified fields including a start bit and an end bit in an encoding protocol layer;
a start bit of the first data packet in the plurality of data packets being a first value, and an end bit being a second value;
a start bit of the last data packet in the plurality of data packets being a second value, and an end bit being a first value; and
start bits and end bits in data packets in the plurality of data packets other than the first data packet and the last data packet being second values.

In some embodiments of the disclosure, based on the foregoing solutions, the network transmission optimization apparatus 1100 further includes: a storage unit, configured to store, after the key frames included in the data stream are identified, the identified key frames, when the key frames are split into a plurality of data packets for transmission, the identified key frames being stored through a key-value pair by using RTP timestamps (RTP.Timestamp) of the key frames as a key and the plurality of data packets as a value.

In some embodiments of the disclosure, based on the foregoing solutions, the storage unit is configured to: store the identified key frames through a hash table; receive a storage space size configured for the hash table; and store a latest received key frame in a queue based on the storage space size.

In some embodiments of the disclosure, based on the foregoing solutions, the network transmission optimization apparatus 1100 further includes: a dropping unit, configured to drop a predetermined quantity of key frames based on a set dropping policy after the key frames included in the data stream are identified. The statistics collection unit 1106 is further configured to count a quantity of received key frame retransmission requests. The processing unit 1108 is further configured to determine, based on the counted quantity of key frame retransmission requests, network quality simulated through key frame dropping.

In some embodiments of the disclosure, based on the foregoing solutions, the receiving unit 1102 is further configured to: perform the operation of dropping a predetermined quantity of key frames based on the set dropping policy when the trigger operation is configured for enabling a network simulation function; and stop the key frame dropping process when the trigger operation is configured for disabling the network simulation function.

In some embodiments of the disclosure, based on the foregoing solutions, the processing unit 1108 performs the network optimization operation for the data receiver in at least one of the following network optimization manners: reducing a transmission bitrate of the data stream and increasing a network bandwidth for the data receiver.

In some embodiments of the disclosure, based on the foregoing solutions, the processing unit 1108 is further configured to: obtain a network feature between the data transmitter and the data receiver and a service feature corresponding to the data stream when it is determined that network optimization may be performed for the data receiver; generate an input parameter of a pre-trained network optimization model based on the network feature and the service feature, the pre-trained network optimization model being obtained through training by using a network feature sample and a service feature sample; input the input parameter into the pre-trained network optimization model, and outputting a network optimization parameter; and perform the network optimization for the data receiver based on the network optimization parameter.

FIG. 12 is a schematic structural diagram of a computer system of an electronic device configured to implement some embodiments.

A computer system 1200 of an electronic device shown in FIG. 12 is merely an example, and does not constitute any limitation on functions and use scope of some embodiments.

As shown in FIG. 12, the computer system 1200 may include a central processing unit (CPU) 1201, which may perform various suitable actions and processes based on a program stored in a read-only memory (ROM) 1202 or a program loaded from a storage part 1208 into a random access memory (RAM) 1203, for example, perform the method in the foregoing embodiments. The RAM 1203 further has various programs and data for system operation stored therein. The CPU 1201, the ROM 1202, and the RAM 1203 are connected to each other through a bus 1204. An input/output (I/O) interface 1205 is also connected to the bus 1204.

The following components may connect to the I/O interface 1205: an input part 1206 including a keyboard, a mouse, or the like; an output part 1207 including a cathode ray tube (CRT), a liquid crystal display (LCD), a speaker, or the like; a storage part 1208 including a hard disk and the like, and a communication portion 1209 including a network interface card such as a local area network (LAN) card and a modem. The communication part 1209 performs communication processing by using a network such as the Internet. A driver 1210 is also connected to the I/O interface 1205. A removable medium 1211, such as a magnetic disk, an optical disc, a magneto-optical disk, or a semiconductor memory, is installed on the driver 1210, so that a computer program read from the removable medium is installed into the storage part 1208.

Particularly, according to some embodiments, the processes described in the following by referring to the flowcharts may be implemented as computer software programs. For example, some embodiments include a computer program product, the computer program product including a computer program carried on a computer-readable medium, the computer program being configured to perform the methods shown in the flowcharts. In such some embodiments, the computer program may be downloaded and installed from a network through the communication part 1209, and/or installed from the removable medium 1211. When the computer program is executed by the CPU 1201, the various functions defined in the system of the disclosure are executed.

The computer-readable medium shown in some embodiments may be a computer-readable signal medium, a computer-readable storage medium, or any combination of the two. The computer-readable storage medium may be, for example, an electric, magnetic, optical, electromagnetic, infrared, or semiconductor system, apparatus, device, or any combination thereof, but is not limited thereto. A more example of the computer-readable storage medium may include but is not limited to an electrical connection having one or more wires, a portable computer magnetic disk, a hard disk, a RAM, a ROM, an erasable programmable read-only memory (EPROM), a flash memory, an optical fiber, a portable compact disk read-only memory (CD-ROM), an optical storage device, a magnetic storage device, or any proper combination thereof. In the disclosure, the computer-readable storage medium may be any tangible medium that includes a computer program or has a computer program stored therein. The computer program may be used by or used in combination with an instruction execution system, apparatus, or device. In the disclosure, the computer-readable signal medium may include a data signal transmitted in a baseband or as a part of a carrier, and carries a computer-readable computer program. The propagated data signal may be in various forms, including but not limited to an electromagnetic signal, an optical signal, or any proper combination thereof. The computer-readable signal medium may be any computer-readable medium other than the computer-readable storage medium. The computer-readable medium can send, propagate, or transmit a program used by or in combination with an instruction execution system, apparatus, or device. The computer program included in the computer-readable medium may be transmitted by using any proper medium, including but not limited to a wireless medium, a wired medium, or any proper combination thereof.

The flowcharts and block diagrams in the drawings illustrate possible system architectures, functions and operations that may be implemented by a system, a method, and a computer program product according to various embodiments of the disclosure. Each box in the flowcharts or the block diagrams may represent a module, a program segment, or a part of code. The module, the program segment, or the part of code includes one or more executable instructions configured for implementing specified logic functions. In some alternative implementations, the functions marked in the blocks may occur in an order different from that marked in the drawings. For example, two blocks shown in succession may actually be performed substantially in parallel, or may sometimes be performed in a reverse order, which depends on the functions involved. Each box in the block diagrams or the flowcharts and combinations of the boxes in the block diagrams or the flowcharts may be implemented by a dedicated hardware-based system that performs specified functions or operations, or may be implemented by a combination of dedicated hardware and a computer program.

The units described in some embodiments may be implemented through software or hardware, and may be arranged in a processor. Names of the units do not constitute a limitation on the units in a case.

In another aspect, the disclosure further provides a computer-readable medium. The computer-readable medium may be included in the electronic device described in the foregoing embodiments, or may exist alone without being installed into the electronic device. The foregoing computer-readable medium carries one or more computer programs. The one or more computer programs, when executed by the electronic device, cause the electronic device to implement the methods described in the foregoing embodiments.

Although a plurality of modules or units of a device configured to perform actions are mentioned in the foregoing detailed description, such division is not mandatory. Actually, according to the implementations of the disclosure, the features and functions of two or more modules or units described above may be implemented in one module or unit. On the contrary, the features and functions of one module or unit described above may be further divided to be embodied by a plurality of modules or units.

According to the foregoing descriptions of the implementations, a person skilled in the art may readily understand that the exemplary implementations described herein may be implemented by using software, or may be implemented by combining software and hardware. Therefore, the technical solutions according to the implementations of the disclosure may be embodied in a form of a software product. The software product may be stored in a non-volatile storage medium (which may be a CD-ROM, a USB flash drive, a removable hard disk, or the like) or on a network, including a plurality of instructions configured for enabling an electronic device (which may be a personal computer, a server, a touch terminal, a network device, or the like) to perform the method according to the implementations of the disclosure.

A person skilled in the art may easily figure out another implementation of the disclosure after considering the specification and practicing the implementations disclosed herein. The disclosure is intended to cover any variations, uses, or adaptive changes of the disclosure. These variations, uses, or adaptive changes follow the general principles of the disclosure and include general knowledge or technical means in the art which are not disclosed in the disclosure.

The disclosure is not limited to the precise structures described above and shown in the drawings, and various modifications and changes may be made without departing from the scope of the disclosure. The scope of the disclosure is subject only to the appended claims.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A network transmission optimization method, performed by an electronic device, the method comprising:
receiving a data stream transmitted between a transmitter and a receiver;
identifying key frames in the data stream;
performing statistics collection on the key frames to obtain key frame statistical information; and
performing a network optimization for the receiver based on determining, using the key frame statistical information, that network optimization is needed for the receiver.

2. The network transmission optimization method according to claim 1,
wherein determining that network optimization is needed for the receiver, based on the key frame statistical information indicating at least one of that:
a quantity of the key frames is greater than or equal to a first quantity threshold;
a growth rate of the key frames within a unit time is greater than or equal to a growth rate threshold; or
the growth rate of the key frames within the unit time is greater than or equal to the set growth rate threshold and that a group of pictures (GOP) length of the data stream is less than or equal to a set length threshold.

3. The network transmission optimization method according to claim 1, further comprising:
determining that network optimization is needed for the receiver based on a quantity of key frame retransmission requests received within the unit time being greater than or equal to a second quantity threshold.

4. The network transmission optimization method according to claim 1, wherein the identifying comprises:
capturing data packets in the data stream;
extracting features of the captured data packets; and
comparing the features of the captured data packets with a feature of a key frame data packet, to identify the key frames in the data stream.

5. The network transmission optimization method according to claim 4,
wherein the comparing comprises:
performing comparison with at least one of the following:
a protocol field in an Internet protocol (IP) header,
a version field in a real-time transport control protocol (RTP) layer,
a padding field in the RTP layer,
an extension field in the RTP layer,
a marker field in the RTP layer, or
a network abstraction layer unit (NALU) type field.

6. The network transmission optimization method according to claim 1, the method further comprising:
identifying, based on the key frames split into a plurality of data packets for transmission, data packets belonging to the key frame based on values of specified fields in the captured data packets,
wherein each of the specified fields comprises a start bit and an end bit in an encoding protocol layer,
wherein a start bit of a first data packet in the plurality of data packets is a first value, and an end bit is a second value,
wherein a start bit of the last data packet in the plurality of data packets is a second value, and an end bit is a first value,
wherein start bits and end bits in data packets in the plurality of data packets excluding the first data packet and the last data packet are second values.

7. The network transmission optimization method according to claim 1, further comprising:
storing, based on the key frames split into a plurality of data packets for transmission, the identified key frames as a key-value pair,
wherein a key of the key-value pair is an RTP timestamp of the key frame, and a value of the key-value pair comprises the plurality of data packets.

8. The network transmission optimization method according to claim 7,
wherein the identified key frame are stored based on a hash table, and the method further comprising:
receiving a storage space size configured for the hash table; and
storing a latest received key frame in a queue based on the storage space size.

9. The network transmission optimization method according to claim 1, further comprising:
dropping a predetermined quantity of key frames based on a dropping policy based on the identified key frames;
counting a quantity of received key frame retransmission requests; and
determining, based on the counted quantity of key frame retransmission requests, network quality simulated through key frame dropping.

10. The network transmission optimization method according to claim 9, further comprising:
receiving a trigger operation associated with a network simulation configuration item;
dropping a predetermined quantity of key frames based on a dropping policy and the trigger operation enabling a network simulation; and
stopping the key frame dropping based on the trigger operation disabling the network simulation.

11. The network transmission optimization method according to claim 1,
wherein the performing a network optimization operation comprises at least one of:
reducing a transmission bitrate of the data stream; or
increasing a network bandwidth for the receiver.

12. The network transmission optimization method according to claim 1, further comprising:
obtaining a network feature between the transmitter and the receiver and a service feature corresponding to the data stream based on determining that network optimization is needed for the receiver;
generating an input parameter of a pre-trained network optimization model based on the network feature and the service feature, the pre-trained network optimization model being obtained through training based on at least one network feature sample and at least one service feature sample;
inputting the input parameter into the pre-trained network optimization model;
outputting a network optimization parameter; and
performing the network optimization for the receiver based on the network optimization parameter.

13. A network transmission optimization apparatus, comprising:
at least one memory configured to store program code; and
at least one processor configured to read the program code and operate as instructed by the program code, the program code comprising:
receiving code configured to cause at least one of the at least one processor to receive a data stream transmitted between a transmitter and a receiver;
identifying code configured to cause at least one of the at least one processor to identify key frames in the data stream;
statistics code configured to cause at least one of the at least one processor to perform statistics collection on the key frames to obtain key frame statistical information; and
optimization code configured to cause at least one of the at least one processor to perform a network optimization for the receiver based on determining, using the key frame statistical information, that network optimization is needed for the receiver.

14. The network transmission optimization apparatus according to claim 13,
wherein the optimization code is further configured to cause at least one of the at least one processor to determine that network optimization is needed for the receiver, based on the key frame statistical information indicating at least one of that:
a quantity of the key frames is greater than or equal to a first quantity threshold;
a growth rate of the key frames within a unit time is greater than or equal to a growth rate threshold; or
the growth rate of the key frames within the unit time is greater than or equal to the set growth rate threshold and that a group of pictures (GOP) length of the data stream is less than or equal to a set length threshold.

15. The network transmission optimization apparatus according to claim 13, wherein the optimization code is further configured to cause at least one of the at least one processor to:
determine that network optimization is needed for the receiver based on a quantity of key frame retransmission requests received within the unit time being greater than or equal to a second quantity threshold.

16. The network transmission optimization apparatus according to claim 13, wherein the identifying code is further configured to cause at least one of the at least one processor to:
capture data packets in the data stream;
extract features of the captured data packets; and
compare the features of the captured data packets with a feature of a key frame data packet, to identify the key frames in the data stream.

17. The network transmission optimization apparatus according to claim 16,
wherein the identifying code is further configured to cause at least one of the at least one processor to:
perform comparison with at least one of the following:
a protocol field in an Internet protocol (IP) header,
a version field in a real-time transport control protocol (RTP) layer,
a padding field in the RTP layer,
an extension field in the RTP layer,
a marker field in the RTP layer, or
a network abstraction layer unit (NALU) type field.

18. The network transmission optimization apparatus according to claim 13, wherein the program code is further configured to cause at least one of the at least one processor to:
identify, based on the key frames split into a plurality of data packets for transmission, data packets belonging to the key frame based on values of specified fields in the captured data packets,
wherein each of the specified fields comprises a start bit and an end bit in an encoding protocol layer,
wherein a start bit of a first data packet in the plurality of data packets is a first value, and an end bit is a second value,
wherein a start bit of the last data packet in the plurality of data packets is a second value, and an end bit is a first value,
wherein start bits and end bits in data packets in the plurality of data packets excluding the first data packet and the last data packet are second values.

19. The network transmission optimization apparatus according to claim 13, wherein the program code is further configured to cause at least one of the at least one processor to:
store, based on the key frames split into a plurality of data packets for transmission, the identified key frames as a key-value pair,
wherein a key of the key-value pair is an RTP timestamp of the key frame, and a value of the key-value pair comprises the plurality of data packets.

20. A non-transitory computer-readable storage medium, storing computer code which, when executed by at least one processor, causes the at least one processor to at least:
receive a data stream transmitted between a transmitter and a receiver;
identify key frames in the data stream;
perform statistics collection on the key frames to obtain key frame statistical information; and
perform a network optimization for the receiver based on determining, using the key frame statistical information, that network optimization is needed for the receiver.
